(19) United States
(12) Patent Application Publication
(10) Pub. No.: US 2023/0205941 A1
(43) Pub. Date: Jun. 29, 2023

(54) METHOD AND SYSTEM FOR TRIMMING INTERSECTING BODIES IN A COMPUTER-AIDED DESIGN ENVIRONMENT

(71) Applicant: Siemens Industry Software Inc., Plano, TX (US)

(72) Inventors: Kirti Sanglikar, Pune (IN); Dhananjay Sarode, Pune (IN); Varshneya Bhogawar, Thane (IN); Aditya Gurushankar, Madison, AL (US); Marcelo A. Martins, Huntsville, AL (US)

(21) Appl. No.: 17/928,420

(22) PCT Filed: Jul. 23, 2020
(86) PCT No.: PCT/IB2020/056945

§ 371 Date: Nov. 29, 2022

(30) Foreign Application Priority Data
Jun. 1, 2020 (IN) 202031022958

(51) Int. Cl. G06F 30/17; G06F 30/27

(52) U.S. Cl. CPC G06F 30/17; G06F 30/27; G06F 2111/04

(57) ABSTRACT

A method and system for trimming intersecting bodies of a geometric model in a computer-aided design environment is disclosed. In one embodiment, a method includes determining a plurality of bodies of the geometric model intersecting with each other. The method includes computing volume of one or more intersecting bodies in the geometric model to be trimmed from the geometric model. Also, the method includes determining a trim offset value for at least one intersecting body in the geometric model and recomputing the volume of the at least one intersecting body in the geometric model which is to be trimmed from the geometric model based on the trim offset value. Moreover, the method includes generating a modified geometric model by performing a trim operation on the volume of the one or more intersecting bodies of the geometric model.

The present patent document is a § 371 nationalization of PCT Application Serial No. PCT/IB2020/056945, filed Jul. 23, 2020, designating the United States, which is hereby incorporated by reference, and this patent document also claims the benefit of Indian Patent Application No. 202031022958, filed Jun. 1, 2020.

### FIELD OF TECHNOLOGY

The present disclosure generally relates to the field of computer-aided design (CAD), and more particularly to a method and system for trimming intersecting bodies in a CAD environment.

### BACKGROUND

Computer-aided design tools enable users to design physical objects in the form of geometric models. When a user creates a geometric model, one or more bodies in the geometric model may intersect with each other. For example, when the user is designing a sheet metal model, bending of flanges may cause interaction with other flanges. The user may need to remove ‘unwanted’ volume of the intersecting bodies (e.g., portion beyond the point of intersection of bodies) to avoid problems in manufacturing of physical objects based on the geometric model. However, removal of ‘unwanted’ volume may be a tedious and cumbersome process using known CAD tools. Also, modifications to the geometric model to remove the ‘unwanted’ volume may lead to inconsistent intersections, resulting in rework on the geometric model. Furthermore, the currently known CAD tools may not provide support for trimming ‘unwanted’ volume when more than two bodies are intersecting with each other.

Due to design requirement, the user may want to maintain a minimum gap between the layer faces of the intersecting bodies. Currently, it may be challenging to remove the ‘unwanted’ volume of the intersecting bodies in such a manner that the minimum gap is maintained between the layer faces of the intersecting bodies.

### SUMMARY

The scope of the present disclosure is defined solely by the appended claims and is not affected to any degree by the statements within this summary. The present embodiments may obviate one or more of the drawbacks or limitations in the related art.

A method and system of trimming intersecting bodies on a geometric model in a computer-aided design (CAD) environment is disclosed. In one aspect, a method includes determining a plurality of bodies of a geometric model in a CAD environment which intersect with each other and computing a volume of one or more intersecting bodies in the geometric model to be trimmed from the geometric model. The geometric model may be a sheet metal model. The plurality of intersecting bodies may be integral part of the geometric model. The one or more intersecting bodies includes at least one of newly created bodies and previously created bodies. Furthermore, the method includes determining a trim offset value for at least one intersecting body in the geometric model based on a minimum gap to be maintained between each pair of the intersecting bodies after performing the trim operation and recomputing the volume of the at least one intersecting body in the geometric model which is to be trimmed from the geometric model based on the trim offset value. Moreover, the method includes generating a modified geometric model by performing a trim operation on the volume of the one or more intersecting bodies of the geometric model.

In computing the volume of the one or more intersecting bodies of the plurality of intersecting bodies in the geometric model to be trimmed, the method may include identifying the one or more intersecting bodies whose portion is to be trimmed from the geometric model and computing the volume of the identified intersection bodies whose portion is to be trimmed from the geometric model. In some embodiments, the method may include computing the volume of the one or more intersection bodies whose portion is to be trimmed from the geometric model using artificial intelligence algorithm.

In determining the trim offset value for the at least one of the one or more intersecting bodies in the geometric model, the method may include computing a distance from a point of an intersection of the intersecting bodies to a point where the minimum gap is attained between the intersecting bodies.

In generating the modified geometric model by performing the trim operation on the volume of the one or more intersecting bodies of the geometric model, the method may include generating the modified geometric model by trimming the volume of the one or more intersecting bodies of the geometric model substantially simultaneously with creation of at least one intersecting body of the plurality of intersecting bodies of the geometric model.

In another aspect, a data processing system includes a processing unit, and an accessible memory operatively coupled to the processing unit. The memory includes a component trimming module configured to determine a plurality of bodies of a geometric model in a CAD environment intersecting with each other, and compute volume of one or more intersecting bodies of the plurality of intersecting bodies in the geometric model to be trimmed from the geometric model. For example, the component trimming module may be configured to identify the one or more intersecting bodies whose portion is to be trimmed from the geometric model and compute the volume of the identified intersection bodies whose portion is to be trimmed from the geometric model. In some embodiments, the component trimming module may be configured to compute the volume of the one or more intersection bodies whose portion is to be trimmed from the geometric model using artificial intelligence algorithm.

Furthermore, the component trimming module is configured to determine a trim offset value for at least one of the one or more intersecting bodies in the geometric model based on a minimum gap to be maintained between each pair of intersecting bodies of the plurality of intersecting bodies after performing the trim operation. For example, the component trimming module may be configured to compute a distance from a point of an intersection of the intersecting bodies to a point where the desired gap is attained between the intersecting bodies. Also, the component trimming module is configured to recompute the volume of the at least one of the one or more intersecting bodies in the geometric model which is to be trimmed from the geometric model based on the trim offset value.

Moreover, the component trimming module is configured to generate a modified geometric model by performing a trim operation on the volume of the one or more intersecting bodies of the geometric model. For example, the component trimming module may be configured to generate the modified geometric model by trimming the volume of the one or more intersecting bodies of the geometric model substantially simultaneously with creation of at least one intersecting body of the plurality of intersecting bodies of the geometric model.

In yet another aspect, a non-transitory computer-readable storage medium, having machine-readable instructions stored therein, that when executed by a data processing system, cause the data processing system to perform method acts described above.

This summary is provided to introduce a selection of concepts in a simplified form that are further described below in the following description. It is not intended to identify features or essential features of the claimed subject matter. Furthermore, the claimed subject matter is not limited to implementations that solve any or all disadvantages noted in any part of this disclosure.

### BRIEF DESCRIPTION OF DRAWINGS

FIG. 1 is a block diagram of an exemplary data processing system for trimming intersecting bodies of a geometric model in a computer-aided design (CAD) environment, according to one embodiment.

FIG. 2 is a process flowchart of an exemplary method of performing a trim operation on intersecting bodies of a geometric model in a CAD environment, according to one embodiment.

FIG. 3 is a schematic representation of a data processing system for performing a trim operation on intersecting bodies on a geometric model in a CAD environment, according to another embodiment.

FIG. 4 illustrates a block diagram of a data processing system for performing a trim operation on intersection bodies of a geometric model in a CAD environment, according to yet another embodiment.

FIG. 5 is a schematic representation of an exemplary trained machine learning model for computing a volume of intersecting bodies of a geometric model which is to be trimmed from the geometric model, according to one embodiment.

FIGS. 6A-6C illustrate schematic representations of a trimming operation performed on a geometric model with intersecting flanges, according to one embodiment.

FIG. 7A illustrates a schematic representation of a sheet metal model including non-coplanar flanges intersecting with each other, according to one embodiment.

FIG. 7B illustrate a schematic representation of a modified sheet metal model after performing a trim operation on one of the flanges, according to one embodiment.

FIG. 8A illustrates a schematic representation of a sheet metal model including non-coplanar flanges intersecting with each other, according to another embodiment.

FIG. 8B illustrate a schematic representation of a modified sheet metal model after performing a trim operation on one of the flanges, according to another embodiment.

FIG. 9A illustrates a schematic representation of a sheet metal model including coplanar flanges intersecting with each other, according to one embodiment.

FIG. 9B illustrate a schematic representation of a modified sheet metal model after performing a trim operation on the flanges, according to another embodiment.

FIG. 10A illustrates a schematic representation of a sheet metal model including multiple adjacent flanges intersecting with each other, according to one embodiment.

FIG. 10B illustrate a schematic representation of a modified sheet metal model after performing a trim operation on multiple adjacent flanges, according to yet another embodiment.

### DETAILED DESCRIPTION

A method and system for performing a trim operation on intersecting bodies of a geometric model in a computer-aided design (CAD) environment is disclosed. Various embodiments are described with reference to the drawings, where like reference numerals are used in reference to the drawings. Like reference numerals are used to refer to like elements throughout. In the following description, numerous specific details are set forth in order to provide a thorough understanding of embodiments. These specific details need not be employed to practice embodiments. In other instances, well known materials or methods have not been described in detail in order to avoid unnecessarily obscuring embodiments. While the disclosure is susceptible to various modifications and alternative forms, specific embodiments thereof are shown by way of example in the drawings and will herein be described in detail. There is no intent to limit the disclosure to the particular forms disclosed. Instead, the disclosure is to cover all modifications, equivalents, and alternatives falling within the spirit and scope of the present disclosure.

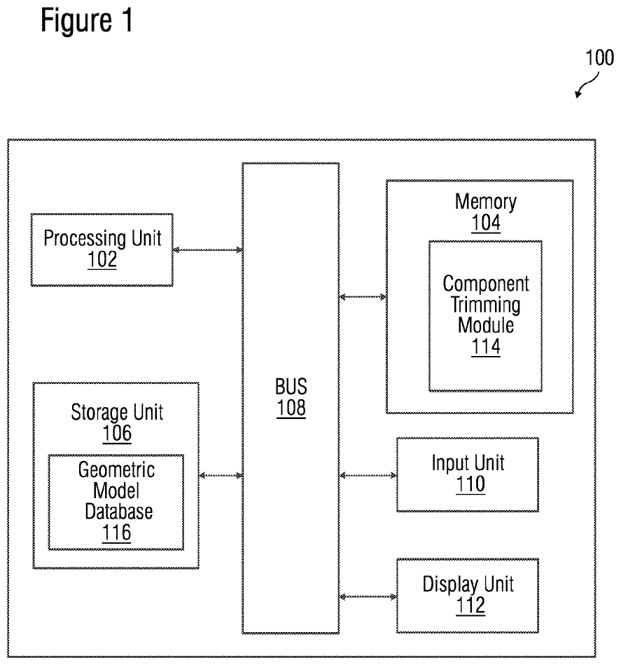

FIG. 1 is a block diagram of an exemplary data processing system 100 for trimming intersecting bodies of a geometric model in a computer-aided design (CAD) environment, according to one embodiment. The data processing system 100 may be a personal computer, a workstation, a laptop computer, a tablet, and the like. In FIG. 1, the data processing system 100 includes a processing unit 102, a memory 104, a storage unit 106, a bus 108, an input unit 110, and a display unit 112. The data processing system 100 is a specific purpose computer configured to trim intersecting bodies of a geometric model.

The processing unit 102, as used herein, means any type of computational circuit, such as, but not limited to, a microprocessor, microcontroller, complex instruction set computing microprocessor, reduced instruction set computing microprocessor, very long instruction word microprocessor, explicitly parallel instruction computing microprocessor, graphics processor, digital signal processor, or any other type of processing circuit. The processing unit 102 may also include embedded controllers, such as generic or programmable logic devices or arrays, application specific integrated circuits, single-chip computers, and the like.

The accessible memory 104 may be non-transitory volatile memory and non-volatile memory. The memory 104 may be coupled for communication with the processing unit 102, such as being a computer-readable storage medium. The processing unit 102 may execute instructions and/or code stored in the memory 104. A variety of computer-readable instructions may be stored in and accessed from the memory 104. The memory 104 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like.

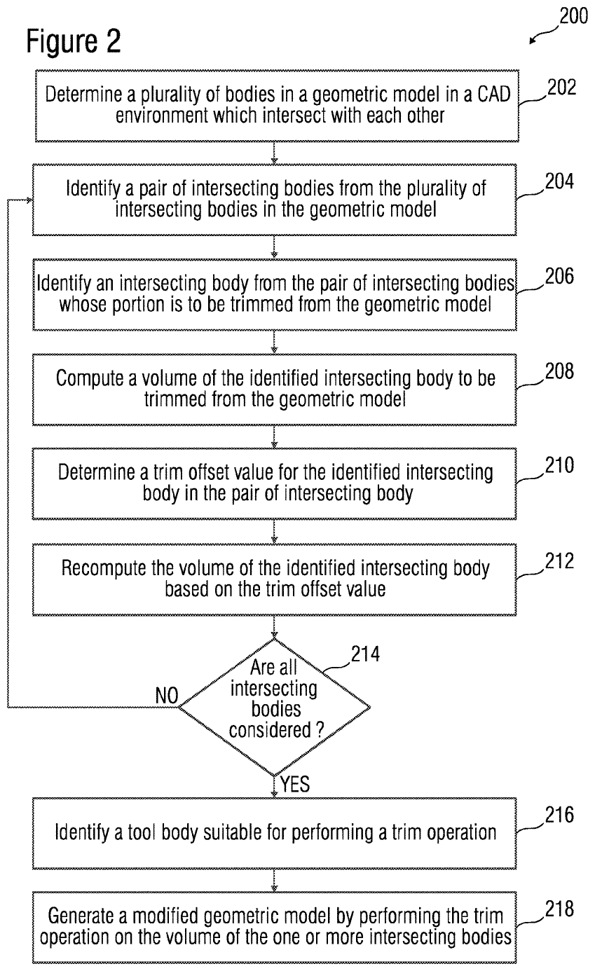

In the present embodiment, the memory 104 includes a component trimming module 114 stored in the form of machine-readable instructions on any of the above-mentioned storage media and may be in communication to and executed by the processing unit 102. When the machine-readable instructions are executed by the processing unit 102, the component trimming module 114 causes the processing unit 102 to determine a plurality of bodies of the geometric model in the CAD environment which intersect with each other and compute a volume of one or more intersecting bodies in the geometric model to be trimmed from the geometric model. The component trimming module 114 causes the processing unit 102 to determine a trim offset value for at least one intersecting body in the geometric model based on minimum gap to be maintained between each pair of the intersecting bodies after performing the trim operation and recompute the volume of the at least one intersecting body in the geometric model which is to be trimmed from the geometric model based on trim offset value. Moreover, the component trimming module 114 causes the processing unit 102 to generate a modified geometric model by performing a trim operation on the volume of the intersecting bodies of the geometric model. Method acts performed by the processing unit 102 to achieve the above functionality are described in greater detail in FIG. 2.

The storage unit 106 may be a non-transitory storage medium which stores a geometric model database 116. The geometric model database 116 stores geometric feature information associated with geometric models. The input unit 110 may include input devices such as keypad, touch-sensitive display, camera (such as a camera receiving gesture-based inputs), etc. capable of receiving input signals such as a trim command for performing a trim operation on the geometric model. The display unit 112 may be a device with a graphical user interface displaying a multi-dimensional visual representation of a geometric model. The graphical user interface may also enable users to select a trim command for performing the trim operation on the geometric model. The bus 108 acts as interconnect between the processing unit 102, the memory 104, the storage unit 106, the input unit 110, and the display unit 112.

Those of ordinary skilled in the art will appreciate that the hardware depicted in FIG. 1 may vary for particular implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter also may be used in addition to or in place of the hardware depicted. The depicted example is provided for the purpose of explanation only and is not meant to imply architectural limitations with respect to the present disclosure.

The data processing system 100 in accordance with an embodiment of the present disclosure includes an operating system employing a graphical user interface. The operating system permits multiple display windows to be presented in the graphical user interface simultaneously with each display window providing an interface to a different application or to a different instance of the same application. A cursor in the graphical user interface may be manipulated by a user through the pointing device. The position of the cursor may be changed and/or an event such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

FIG. 2 is a process flowchart 200 of an exemplary method of performing a trim operation on intersecting bodies of a geometric model in a CAD environment, according to one embodiment. At act 202, a plurality of bodies in the geometric model in the CAD environment which intersect with each other is determined. The plurality of bodies may be integral part of the geometric model. The plurality of bodies may be newly created bodies and previously created bodies. The plurality of bodies is automatically tagged as newly created or previously created when an intersection between the plurality of bodies is determined. For example, the plurality of bodies may include flanges of a sheet metal model. In one embodiment, one or more bodies of the geometric model being newly created are instantaneously determined as intersecting with previously created bodies of the geometric model. In another embodiment, the plurality of previously created bodies in the geometric model are determined as intersecting with each other. In yet another embodiment, the plurality of bodies in the geometric model are found as intersecting when a geometric parameter (e.g., angle, length, height, width, etc.) of one body of the plurality of bodies is modified by a user.

At act 204, a pair of intersecting bodies from the plurality of intersecting bodies in the geometric model is identified. In case the geometric model includes more than two intersecting bodies, a pair of intersecting bodies are selected each time from the plurality of intersecting bodies till the last pair of intersecting bodies. Acts 204 to 214 are performed for each pair of the intersecting bodies. The process acts 204 to 214 are repeated till all the pairs in the intersecting bodies are covered in the geometric model.

At act 206, an intersecting body from the pair of intersecting bodies whose portion is to be trimmed from the geometric model are identified. In one embodiment, an intersecting body in the geometric model whose portion beyond intersection is to be trimmed is identified based on pre-defined criteria. In case the intersecting bodies are non-coplanar, a layer face of one intersecting body from the pair of intersecting bodies which is nearest to a bend of another intersecting body is determined. The intersecting body having the layer face nearest to the bend of the other intersecting body is identified for performing a trim operation. In an exemplary implementation, an intersecting body is determined to have a layer face nearest to bend of another intersecting body if the intersecting body is tagged as newly created. In another exemplary implementation, if both the intersecting bodies are tagged as previously created, then one of the intersecting bodies is identified for the trim operation which has a layer face making an angle of <90 degrees with a layer face of another intersecting body.

The data processing system 100 may be configured to automatically identify the intersecting body from the pair of intersecting bodies based on the pre-defined criteria. In another embodiment, the data processing system 100 may be configured to identify intersecting bodies from the pair of intersecting bodies using a trained machine learning model. In yet another embodiment, the data processing system identifies the intersecting body from the pair of intersecting bodies based on a selection by a user. For example, the user may select the one of interesting bodies from the pair of intersecting bodies whose portion needs to be trimmed from the geometric model.

At act 208, a volume of the identified intersecting body to be trimmed from the geometric model is computed. In one embodiment, the data processing system 100 is configured to compute the volume of the identified intersecting body to be trimmed from the geometric model using a trained machine learning model (e.g., a convolutional neural network). For example, the trained machine learning model may identify portions of the identified intersecting body which needs to be trimmed from the geometric model. The trained machine learning model may compute the volume of the intersecting bodies based on position of the intersecting bodies (e.g., coplanar, non-coplanar, etc.).

At act 210, a trim offset value for the identified intersecting body in the pair of intersecting bodies is determined. In some embodiments, the data processing system 100 is configured to compute a trim offset value for the identified intersecting body based on a minimum gap to be maintained between the pair of the intersecting bodies. In these embodiments, the data processing system 100 is configured to compute a distance (e.g., the trim offset value) from a point of an intersection of the intersecting bodies to a point where the minimum gap is attained between the layer faces of the intersecting bodies. The distance is computed from the point of intersection to the point where the minimum gap is achieved along the lateral face of the identified intersecting body. At act 212, the volume of the identified intersecting body is recomputed based on the trim offset value. At act 214, it is determined whether all intersecting bodies in the geometric model are considered for performing the trim operation. If, at act 214, it is determined that any intersecting body is not considered for performing the trim operation, then the process 200 is routed to act 204, and acts 204 to 214 are repeated.

If, at act 214, it is determined that all intersecting bodies are considered for performing the trim operation, then act 216 is performed. At act 216, a tool body suitable for performing the trim operation is identified. At act 218, a modified geometric model is generated by performing the trim operation on the volume of the one or more intersecting bodies of the geometric model. In some embodiments, the modified geometric model is generated by trimming the volume of the one or more intersecting bodies on-the-fly during creation of at least one intersecting body of the plurality of intersecting bodies of the geometric model.

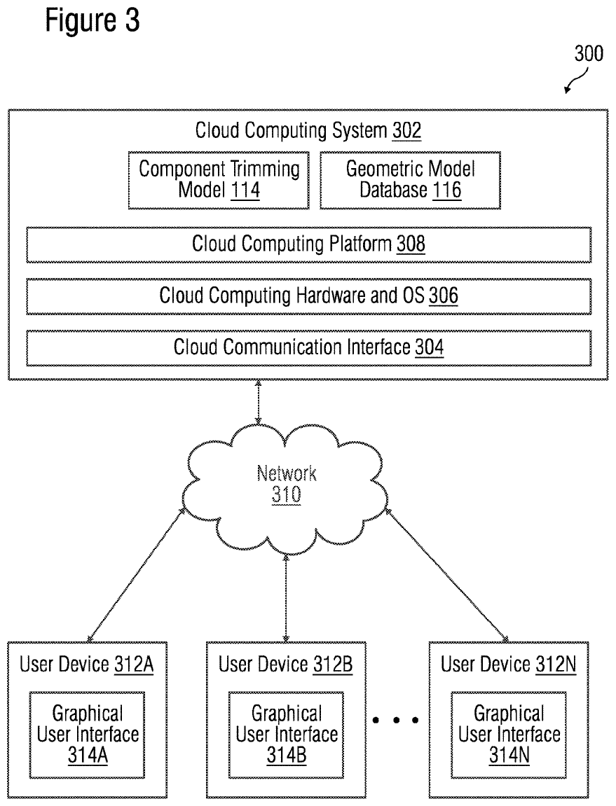

FIG. 3 is a schematic representation of a data processing system 300 for performing a trim operation on intersecting bodies on a geometric model, according to another embodiment. Particularly, the data processing system 300 includes a cloud computing system 302 configured for providing cloud services for designing geometric components.

The cloud computing system 302 includes a cloud communication interface 306, cloud computing hardware and OS 308, a cloud computing platform 310, the component trimming module 114, and the geometric model database 116. The cloud communication interface 306 enables communication between the cloud computing platform 310, and user devices 312A-N such as smart phone, tablet, computer, etc. via a network 304.

The cloud computing hardware and OS 308 may include one or more servers on which an operating system (OS) is installed and includes one or more processing units, one or more storage devices for storing data, and other peripherals required for providing cloud computing functionality. The cloud computing platform 310 is a platform which implements functionalities such as data storage, data analysis, data visualization, data communication on the cloud hardware and OS 308 via Application Programming Interfaces (APIs) and algorithms; and delivers the aforementioned cloud services using cloud based applications (e.g., computer-aided design application). The cloud computing platform 310 employs the component trimming module 114 for performing trimming operation on a geometric model as described in FIG. 2. The cloud computing platform 310 also includes the geometric model database 116 for storing geometric models and/or computer-aided design files for manufacturing the components using additive manufacturing process. The cloud computing platform 310 may include a combination of dedicated hardware and software built on top of the cloud hardware and OS 308.

In accordance with the foregoing embodiments, the cloud computing system 302 may enable users to perform trim operation on intersecting bodies of a geometric in a CAD environment. In particular, the component trimming module 114 may determine a plurality of bodies of the geometric model in the CAD environment which intersect with each other and compute a volume of one or more intersecting bodies in the geometric model to be trimmed from the geometric model. Also, the component trimming module 114 may determine a trim offset value for at least one intersecting body in the geometric model based on minimum gap to be maintained between each pair of the intersecting bodies after performing the trim operation and recompute the volume of the at least one intersecting body in the geometric model which is to be trimmed from the geometric model based on trim offset value. Furthermore, the component trimming module 114 may generate a modified geometric model by performing a trim operation on the volume of the intersecting bodies of the geometric model.

The user devices 312A-N include graphical user interfaces 314A-N for receiving a selection of CAD commands and displaying CAD environment with geometric models. Each of the user devices 312A-N may be provided with a communication interface for interfacing with the cloud computing system 302. Users of the user devices 312A-N may access the cloud computing system 302 via the graphical user interfaces 314A-N. For example, the users may send request to the cloud computing system 302 to perform a trim operation on intersecting bodies of a geometric model. The graphical user interfaces 314A-N may be specifically designed for accessing the component trimming module 114 in the cloud computing system 302.

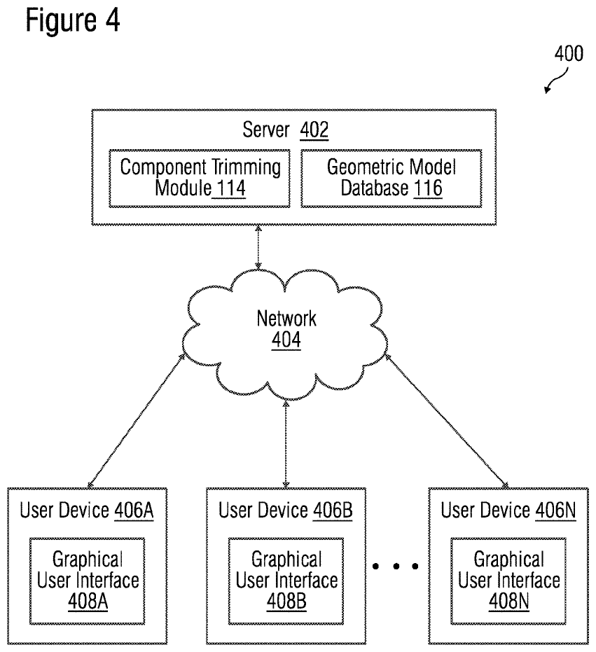

FIG. 4 illustrates a block diagram of a data processing system 400 for performing a trim operation on intersection bodies of a geometric model in a CAD environment, according to yet another embodiment. Particularly, the data processing system 400 includes a server 402 and a plurality of user devices 406A-N. Each of the user devices 406A-N is connected to the server 402 via a network 404 (e.g., Local Area Network (LAN), Wide Area Network (WAN), Wi-Fi, etc.). The data processing system 400 is another implementation of the data processing system 100 of FIG. 1, wherein the component trimming module 114 resides in the server 402 and is accessed by user devices 406A-N via the network 404.

The server 402 includes the component trimming module 114, and the geometric model database 116. The server 402 may also include a processor, a memory, and a storage unit. The component trimming module 114 may be stored on the memory in the form of machine-readable instructions and executable by the processor. The geometric model database 116 may be stored in the storage unit. The server 402 may also include a communication interface for enabling communication with client devices 406A-N via the network 404.

When the machine-readable instructions are executed, the component trimming module 114 causes the server 402 to determine volume of intersecting bodies in a geometric model to be trimmed from the geometric model and generating a modified geometric model by performing a trim operation on the volume of the intersecting bodies in the geometric model. Method acts performed by the server 402 to achieve the above-mentioned functionality are described in greater detail in FIG. 2.

The user devices 406A-N include graphical user interfaces 408A-N for receiving a selection of CAD commands (e.g., trim command) and displaying a CAD environment including geometric models. Each of the user devices 406A-N may be provided with a communication interface for interfacing with the server 402. Users of the user devices 406A-N may access the server 402 via the graphical user interfaces 408A-N. For example, the users may send request to the server 402 to perform a trim operation on the intersecting bodies of the geometric model. The graphical user interfaces 408A-N may be specifically designed for accessing the component trimming module 114 in the server 402.

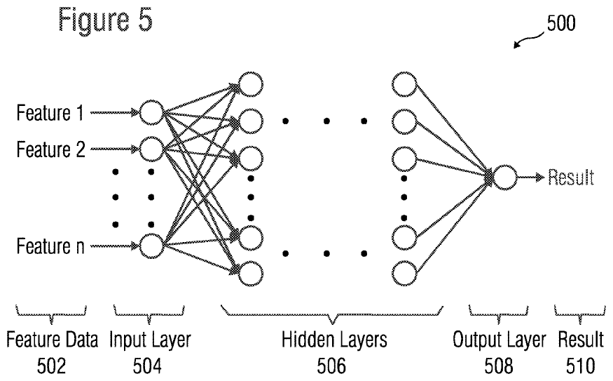

FIG. 5 is a schematic representation of an exemplary trained machine learning model 500 for computing volume of intersecting bodies of a geometric model which is to be trimmed from the geometric model, according to one embodiment. The machine learning model 500 shown in FIG. 5 is deep neural network model such as a convolutional neural network model. The deep neural network model 500 includes an input layer 504, hidden layers 506, and output layer 508. Each of the layers 504-508 includes one or more nodes. Each node is associated with a weighted coefficient.

The deep neural network model 500 is recursively trained to accurately predict volume of one or more intersecting bodies which needs to be trimmed from the geometric model using a training data set. During training, the weighted coefficients assigned to each node of the layers 504-508 are refined till results (e.g., predicted volume of each intersecting body) at the output layer 508 matches an expected output (e.g., expected volume of each intersecting body). In one embodiment, the deep neural network model 500 is trained prior to deploying in the component trimming module 114. In another embodiment, the deep neural network model 500 is trained post deployment in the component trimming module 114 in a self-learning mode.

When the component trimming module 114 deploys the deep neural network model 500, the deep neural network model 500 processes input features 502 (e.g., pixel data) associated with intersecting bodies of a geometric model and outputs results 510 in the form of volume of the intersecting bodies to be trimmed from the geometric model.

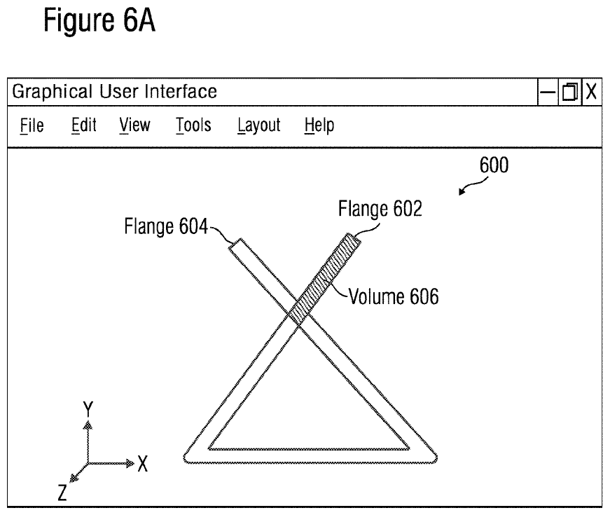

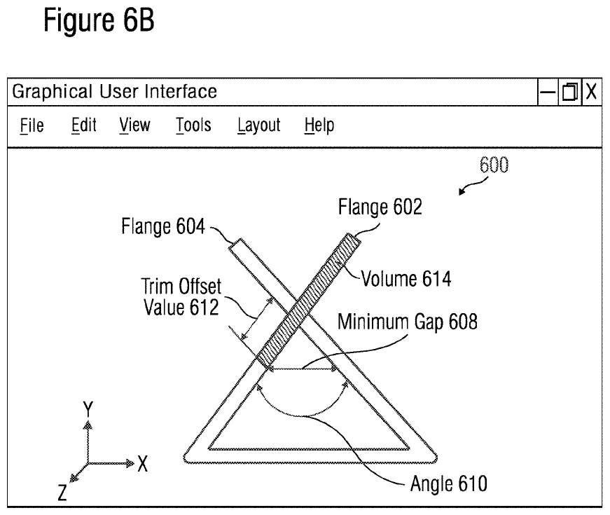

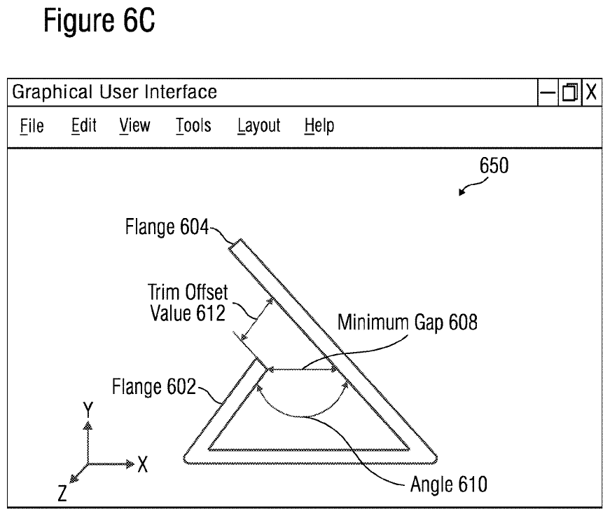

FIGS. 6A-6C illustrate schematic representations of a trimming operation performed on a geometric model 600 with intersecting flanges 602 and 604, according to one embodiment. As shown in FIG. 6A, the geometric model is a sheet metal model. The flanges 602 and 604 are integral parts of the sheet metal model 600. The flanges 602 and 604 intersect with each other. Consider that, when a user creates the flange 602 using a CAD command, the component trimming module 114 identifies the flange 602 whose portion needs to be trimmed from the sheet metal model 600 as the flange 602 is a newly created flange. Accordingly, the component trimming module 114 computes volume 606 of the flange 602 that needs to be trimmed from the sheet metal model 600.

Referring to FIG. 6B, consider that a user wishes to maintain a minimum gap 608 between layer faces of the flanges 602 and 604. The component trimming module 114 determine trim offset value 612 for the flange 602 based on the minimum gap 608 between the layer faces of the flanges 602 and 604 and an angle 610 between the layer faces of the flanges 602 and 604. As can be seen from FIG. 6B, the trim offset value 612 is a distance computed from a point of intersection of the flanges 602 and 604 (e.g., the layer face of the flange 604) to a point where the minimum gap between the layer faces of the flanges 602 and 604 is attained. In an exemplary implementation, the trim offset value 612 is computed using below formulae:

Trim offset value 612=minimum gap 610/(2*sin(Angle 610/2))

In case one of the flanges 602 and 604 is perpendicular to a plane, the trim offset value 612 is computed using below formulae:

Trim offset value 612=minimum gap 610/(sin(Angle 610))

In case the flanges are co-planar, a trim offset value is half of a minimum gap defined by user.

The component trimming module 114 recomputes volume 614 of the flange 602 to be trimmed from the sheet metal model 600 based on the trim offset value 612. In an exemplary embodiment, the component trimming module 114 computes additional volume of the flange 602 to be trimmed to maintain the minimum gap based on the trim offset value 612. The component trimming module 114 computes total volume 614 of the flange 602 to be trimmed based on the additional volume of the flange 602 to be trimmed in addition to the volume 606 computed in FIG. 6A.

Referring to FIG. 6C, the component trimming module 114 performs a trim operation on the flange 602 resulting in trimming the volume 614 from the sheet metal module 600. Consequently, the component trimming module 114 generates a modified sheet metal model 650 based on the trim operation performed on the flange 602.

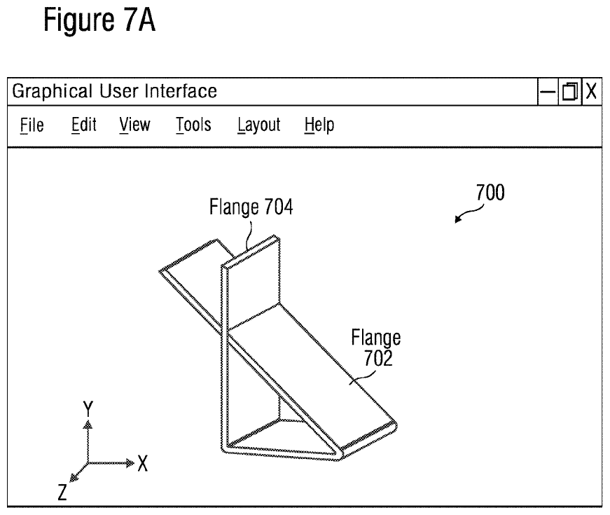

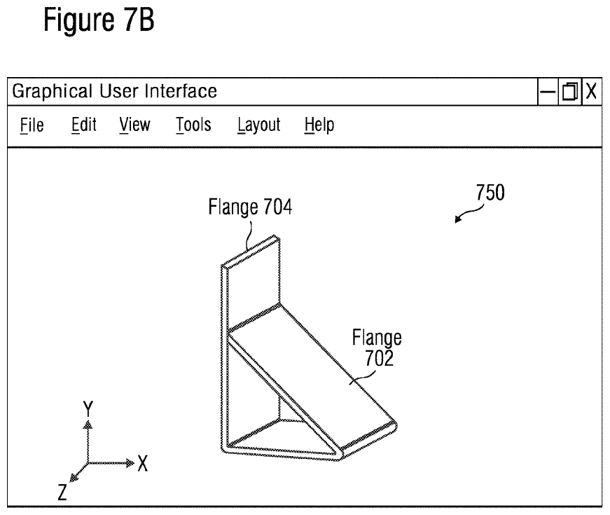

FIG. 7A illustrates a schematic representation of a sheet metal model 700 including flanges 702 and 704. The sheet metal model 700 includes flanges 702 and 704 which are non-coplanar. The flanges 702 and 704 have layer faces non-parallel (e.g., the both flanges 702 and 704 meet at an angle).

FIG. 7B illustrate a schematic representation of a modified sheet metal model 750 after performing a trim operation on the flange 702. As shown in FIG. 7B, the component trimming module 114 generates the modified sheet metal model 750 by performing the trim operation on the volume of the flange 702. One skilled in the art may realize that the component trimming module 114 performs trim operation on the flange 702 as the flange 702 is a newly created flange whereas the flange 704 is a previously created flange.

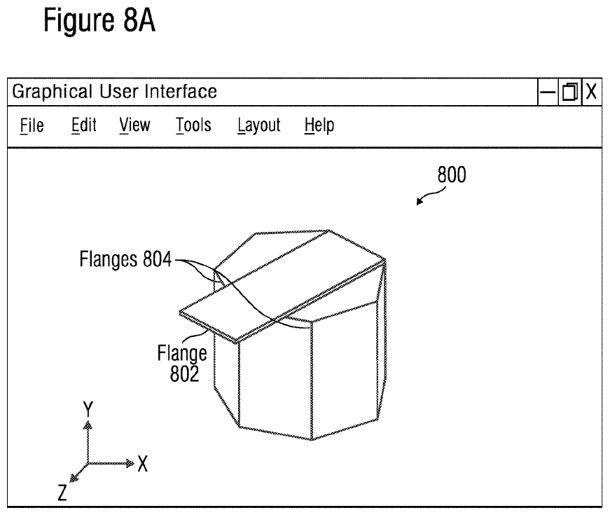

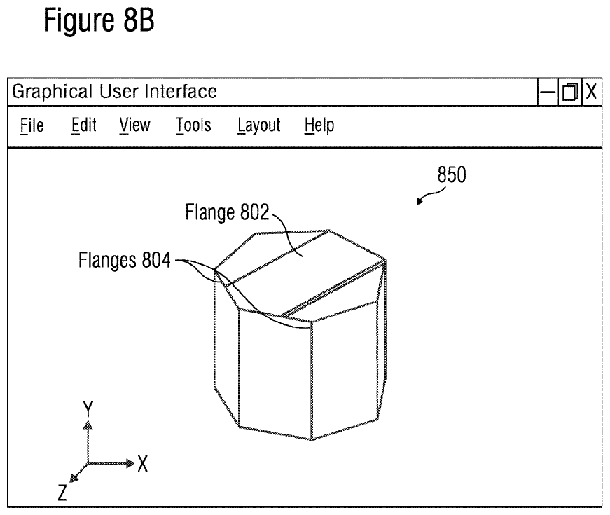

FIG. 8A illustrates a schematic representation of a sheet metal model 800 including flanges 802 and 804. The sheet metal model 800 includes flanges 802 and 804 which are non-coplanar.

FIG. 8B illustrate a schematic representation of a modified sheet metal model 850 after performing a trim operation on the flange 802. As shown in FIG. 8B, the component trimming module 114 generates the modified sheet metal model 850 by performing the trim operation on the volume of the flange 802. One skilled in the art may realize that the component trimming module 114 performs trim operation on the flange 802 as the flange 802 is a newly created flange whereas the flanges 804 are previously created flanges.

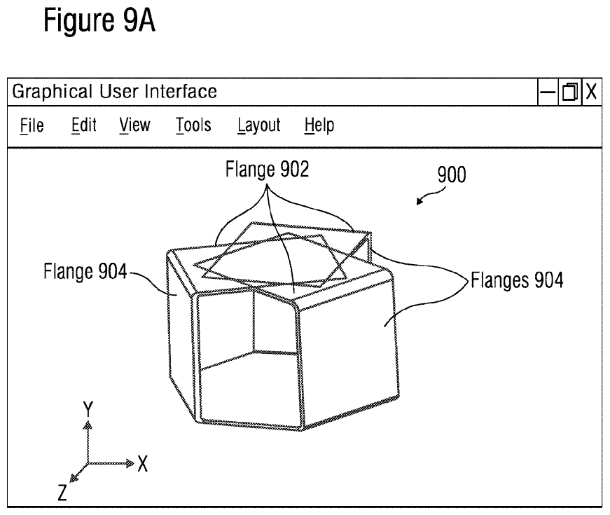

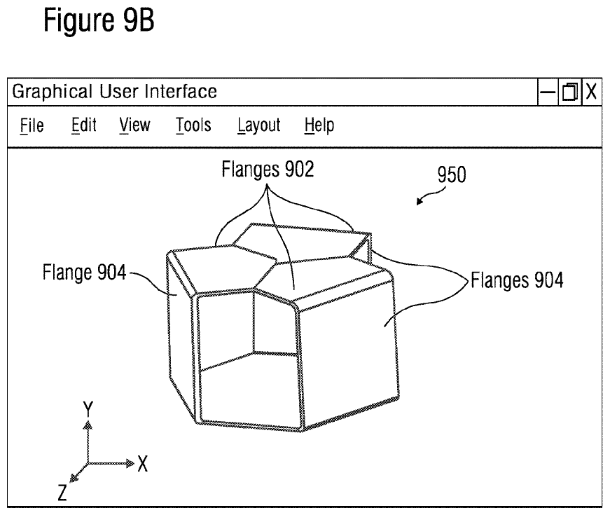

FIG. 9A illustrates a schematic representation of a sheet metal model 900 including flanges 902 and 904. The sheet metal model 900 includes flanges 902, which are coplanar to each other.

FIG. 9B illustrate a schematic representation of a modified sheet metal model 950 after performing a trim operation on the flanges 902. As shown in FIG. 9B, the component trimming module 114 generates the modified sheet metal model 950 by performing the trim operation on the volume of the flanges 902.

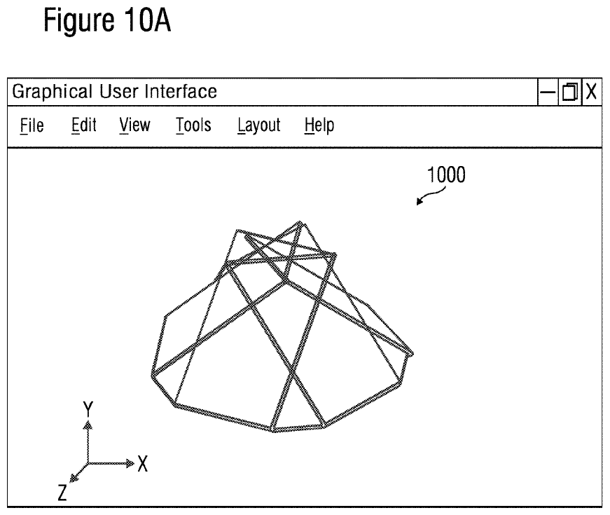

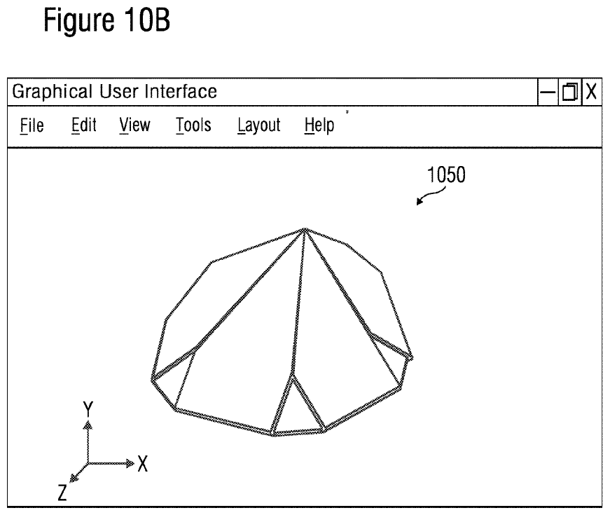

FIG. 10A illustrates a schematic representation of a sheet metal model 1000 including multiple adjacent flanges intersecting with each other.

FIG. 10B illustrate a schematic representation of a modified sheet metal model 1050 after performing a trim operation on the multiple adjacent flanges. As shown in FIG. 10B, the component trimming module 114 generates the modified sheet metal model 1050 by performing the trim operation on the unwanted volume of the flanges.

In various embodiments, the data processing system of FIGS. 1, 3 and 4 provides automatic trimming of portion of intersecting bodies (e.g., co-planar and non-co-planar) in a geometric model to prevent bodies from intersecting with each other. The data processing system trims volume of an intersecting body on-the-fly during creation of the intersecting body. In some embodiment, the data processing system computes volume of the intersecting body using artificial intelligence algorithm (e.g., trained machine learning model). Further, the data processing system trims volume of the intersecting body in such a manner that a desired gap is maintained with layer faces of two intersecting bodies. Also, the data processing system is capable of automatically removing intersection of multiple intersecting bodies.

Of course, those skilled in the art will recognize that, unless specifically indicated or required by the sequence of operations, certain acts in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system may conform to any of the various current implementation and practices known in the art.

It is to be understood that the system and methods described herein may be implemented in various forms of hardware, software, firmware, special purpose processors, or a combination thereof. One or more of the present embodiments may take a form of a computer program product including program modules accessible from computer-usable or computer-readable medium storing program code for use by or in connection with one or more computers, processors, or instruction execution system. For the purpose of this description, a computer-usable or computer-readable medium may be any apparatus that may contain, store, communicate, propagate, or transport the program for use by or in connection with the instruction execution system, apparatus, or device. The medium may be electronic, magnetic, optical, electromagnetic, infrared, or semiconductor system (or apparatus or device) or a propagation mediums in and of themselves as signal carriers are not included in the definition of physical computer-readable medium include a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and digital versatile disc (DVD). Both processors and program code for implementing each aspect of the technology may be centralized or distributed (or a combination thereof) as known to those skilled in the art.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described in detail with reference to certain embodiments, it should be appreciated that the present disclosure is not limited to those embodiments. In view of the present disclosure, many modifications and variations would be present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within their scope.

1. A method of performing a trim operation on intersecting bodies of a geometric model in a computer-aided design (CAD) environment, the method comprising:
determining, by a data processing system, a plurality of bodies of the geometric model in the CAD environment which intersect with each other;
computing, by the data processing system, a volume of one or more intersecting bodies of the plurality of intersecting bodies in the geometric model to be trimmed from the geometric model;
determining, by the data processing system, a trim offset value for at least one intersecting body of the one or more intersecting bodies in the geometric model based on a minimum gap to be maintained between each pair of intersecting bodies of the plurality of intersecting bodies;
recomputing, by the data processing system, the volume of the at least one intersecting body of the one or more intersecting bodies in the geometric model to be trimmed from the geometric model based on the trim offset value; and
generating, by the data processing system, a modified geometric model by performing the trim operation on the volume of the one or more intersecting bodies of the geometric model.

2. The method of claim 1, wherein the computing of the volume of the one or more intersecting bodies of the plurality of intersecting bodies in the geometric model to be trimmed comprises:
identifying the one or more intersecting bodies of the plurality of intersecting bodies whose portion is to be trimmed from the geometric model; and
computing the volume of the identified one or more intersection bodies whose portion is to be trimmed from the geometric model.

3. The method of claim 2, wherein the computing of the volume of the identified one or more intersection bodies whose portion is to be trimmed from the geometric model comprises:
computing the volume of the one or more intersection bodies of the plurality of intersecting bodies whose portion is to be trimmed from the geometric model using an artificial intelligence algorithm.

4. The method of claim 3, wherein the one or more intersecting bodies of the plurality of intersecting bodies comprises at least one body of newly created bodies and previously created bodies.

5. The method of claim 1, wherein the determining of the trim offset value for the at least one intersecting body of the one or more intersecting bodies in the geometric model comprises:
computing a distance from a point of an intersection of respective intersecting bodies to a point where the minimum gap is attained between the respective intersecting bodies.

6. The method of claim 1, wherein the generating of the modified geometric model by performing the trim operation on the volume of the one or more intersecting bodies of the geometric model comprises:
generating the modified geometric model by trimming the volume of the one or more intersecting bodies of the geometric model simultaneously with creation of at least one intersecting body of the plurality of intersecting bodies of the geometric model.

7. The method of claim 1, wherein the one or more intersecting bodies of the plurality of intersecting bodies are an integral part of the geometric model.

8. The method of claim 1, wherein the geometric model is a sheet metal model.

9. A data processing system comprising:
a processing unit; and
an accessible memory operatively coupled to the processing unit, wherein the memory is configured to:
determine a plurality of intersecting bodies of a geometric model in a computer-aided design (CAD) environment intersecting with each other;
compute volume of one or more intersecting bodies of the plurality of intersecting bodies in the geometric model to be trimmed from the geometric model;
determine a trim offset value for at least one intersecting body of the one or more intersecting bodies in the geometric model based on a minimum gap to be maintained between each pair of intersecting bodies of the plurality of intersecting bodies;
recompute the volume of the at least one intersecting body of the one or more intersecting bodies in the geometric model to be trimmed from the geometric model based on the trim offset value; and
generate a modified geometric model by performing a trim operation on the volume of the one or more intersecting bodies of the geometric model.

10. The data processing system of claim 9, wherein memory is further configured to:
identify the one or more intersecting bodies of the plurality of intersecting bodies whose portion is to be trimmed from the geometric model; and
compute the volume of the identified one or more intersection bodies whose portion is to be trimmed from the geometric model.

11. The data processing system of claim 10, wherein the memory is further configured to:
compute the volume of the one or more intersection bodies of the plurality of intersecting bodies whose portion is to be trimmed from the geometric model using an artificial intelligence algorithm.

12. The data processing system of claim 9, wherein the memory is further configured to:
compute a distance from a point of an intersection of respective intersecting bodies to a point where a desired gap is attained between the respective intersecting bodies.

13. The data processing system of claim 9, wherein the memory is further configured to:
generate the modified geometric model by trimming the volume of the one or more intersecting bodies of the plurality of intersecting bodies of the geometric model simultaneously with creation of at least one intersecting body of the plurality of intersecting bodies of the geometric model.

14. The data processing system of claim 9, wherein the one or more intersecting bodies of the plurality of intersecting bodies are an integral part of the geometric model.

15. The data processing system of claim 9, wherein the geometric model is a sheet metal model.

16. A non-transitory computer-readable storage medium, having machine-readable instructions stored therein, that when executed by a data processing system, cause the data processing system to:
determine a plurality of bodies of a geometric model in a computer-aided design (CAD) environment intersecting with each other;
compute volume of one or more intersecting bodies of the plurality of intersecting bodies in the geometric model to be trimmed from the geometric model;
determine a trim offset value for at least one intersecting body of the one or more intersecting bodies in the geometric model based on a minimum gap to be maintained between each pair of intersecting bodies of the plurality of intersecting bodies;
recompute the volume of the at least one intersecting body of the one or more intersecting bodies in the geometric model to be trimmed from the geometric model based on the trim offset value; and
generate a modified geometric model by performing a trim operation on the volume of the one or more intersecting bodies of the geometric model.

17. The storage medium of claim 16, wherein, in the computing of the volume of the one or more intersecting bodies in the geometric model to be trimmed from the geometric model, the instructions cause the data processing system to:
identify the one or more intersecting bodies of the plurality of intersecting bodies whose portion is to be trimmed from the geometric model; and
compute the volume of the identified one or more intersection bodies whose portion is to be trimmed from the geometric model.

18. The storage medium of claim 17, wherein, in the computing of the volume of the identified one or more intersection bodies whose portion is to be trimmed from the geometric model, the instructions cause the data processing system to:
compute the volume of the one or more intersection bodies of the plurality of intersecting bodies whose portion is to be trimmed from the geometric model using an artificial intelligence algorithm.

19. The storage medium of claim 16, wherein, in the determining of the trim offset value for the at least one intersecting body of the one or more intersecting bodies in the geometric model, the instructions cause the data processing system to:
compute a distance from a point of an intersection of respective intersecting bodies to a point where a desired gap is attained between the respective intersecting bodies.

20. The storage medium of claim 16, wherein, in the generating of the modified geometric model by the performing of the trim operation on the volume of the one or more intersecting bodies of the geometric model, the instructions cause the data processing system to:
generate the modified geometric model by trimming the volume of the one or more intersecting bodies of the geometric model simultaneously with creation of at least one intersecting body of the plurality of intersecting bodies of the geometric model.
